(19) United States
(12) Patent Application Publication
(10) Pub. No.: US 2023/0078838 A1
(43) Pub. Date: Mar. 16, 2023

(54) COMPOSITE MATERIAL STRUCTURE

(71) Applicant: MITSUBISHI HEAVY INDUSTRIES, LTD., Tokyo (JP)

(72) Inventors: Atsuma UNO, Tokyo (JP); Tomoo TAKIZAWA, Tokyo (JP); Hiroaki YAMAGUCHI, Tokyo (JP); Atsushi OKADA, Tokyo (JP); Shunsuke YOSHINO, Tokyo (JP); Toshinobu MURAKI, Tokyo (JP)

(21) Appl. No.: 17/796,773

(22) PCT Filed: Jan. 15, 2021
(86) PCT No.: PCT/JP2021/001299

§ 371 Date: Aug. 1, 2022

(30) Foreign Application Priority Data
Feb. 12, 2020 (JP) 2020-021460

(51) Int. Cl. B32B 7/12; B64C 1/06; B32B 5/24

(52) U.S. Cl. CPC B32B 7/12; B64C 1/06; B32B 5/24; B32B 2307/202; B32B 2307/206; B32B 2457/04; B32B 2605/18; B32B 2260/023

(57) ABSTRACT

This composite material structure is provided with: a first composite material that is obtained by stacking a plurality of first composite material sheets, each of which is obtained by impregnating electroconductive first reinforcing fibers with a first resin; a second composite material which is obtained by impregnating electroconductive second reinforcing fibers with a second resin; an insulating bonding layer that is arranged between the first composite material and the second composite material, thereby bonding the first composite material and the second composite material to each other; and an electroconductive member that connects the plurality of first composite material sheets.

### TECHNICAL FIELD

The present disclosure relates to a composite structure.

### BACKGROUND ART

In recent years, a composite material in which a reinforcing fiber is impregnated with a resin has been used as a structure forming a structure such as an aircraft, an automobile, a vehicle, or a ship. A structure is integrated by joining a plurality of composite materials to each other. The joining of the composite materials includes bonding with an adhesive or the like and fastening with bolts and nuts. The bonding with an adhesive or the like is cheaper than the fastening with bolts and nuts, and allows a reduction in weight of the structure.

On the one hand, in a structure in which composite materials are joined to each other by bonding with an adhesive or the like, a conductance in a direction orthogonal to an in-plane direction is smaller than a conductance in the in-plane direction. For this reason, when a lightning current flows into the structure, a large current may flow locally. In general, in a composite structure, permanent conduction by a metal fastener is secured in a laminating direction of composite materials, as a lightning protection measure. For example, the following patent literature discloses such a composite structure.

### CITATION LIST

### Patent Literature

[PTL 1] Japanese Unexamined Patent Application Publication No. 2019-142479

### SUMMARY OF INVENTION

### Technical Problem

In the above-described composite structure of the related art, the metal fastener is applied as a lightning protection measure, thereby causing an increase in the weight of the composite structure itself, which is a problem.

The present disclosure is conceived to solve the above-described problem, and an object of the present disclosure is to provide a composite structure in which a lightning protection measure can be implemented while an increase in weight is suppressed.

### Solution to Problem

In order to achieve the above object, a composite structure according to an aspect of the present disclosure includes: a first composite material in which a plurality of first composite sheets in each of which a first reinforcing fiber having conductivity is impregnated with a first resin are laminated; a second composite material in which a second reinforcing fiber having conductivity is impregnated with a second resin; an insulating adhesive layer disposed between the first composite material and the second composite material to bond the first composite material and the second composite material; and a conductive member that connects the plurality of first composite sheets.

### Advantageous Effects of Invention

According to the composite structure of the present disclosure, it is possible to implement a lightning protection measure while suppressing an increase in weight.

### BRIEF DESCRIPTION OF DRAWINGS

FIG. 1 is a perspective view illustrating a composite structure of a first embodiment.

FIG. 2 is a cross-sectional view illustrating the composite structure of the first embodiment.

FIG. 3 is a cross-sectional view of main parts illustrating the composite structure of the first embodiment.

FIG. 4 is a perspective view illustrating a composite structure of a second embodiment.

FIG. 5 is a cross-sectional view of main parts illustrating the composite structure of the second embodiment.

FIG. 6 is a cross-sectional view of main parts illustrating a composite structure of a third embodiment.

### DESCRIPTION OF EMBODIMENTS

Exemplary embodiments of the present disclosure will be described in detail below with reference to the drawings. However, the present disclosure is not limited by the embodiments, and in the case of a plurality of embodiments, the present disclosure also includes a configuration that is a combination of the embodiments. In addition, components in the embodiments include those that can be easily assumed by those skilled in the art, and those that are substantially the same, namely, those in the range of so-called equivalents.

### First Embodiment

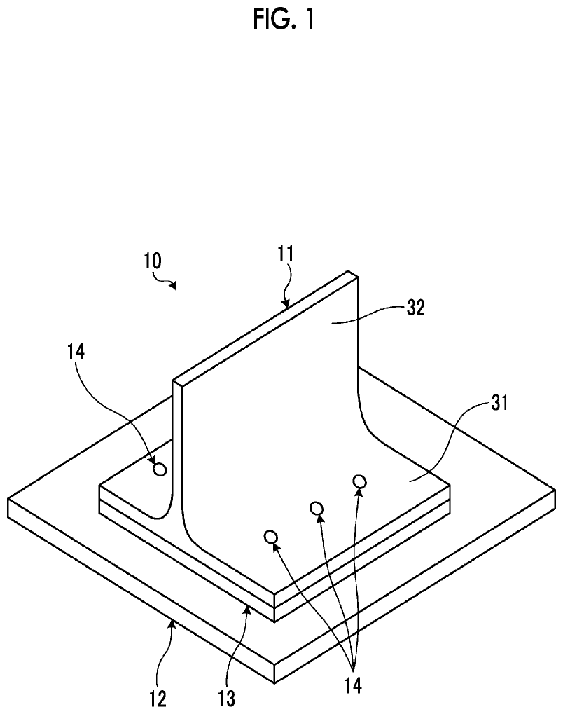

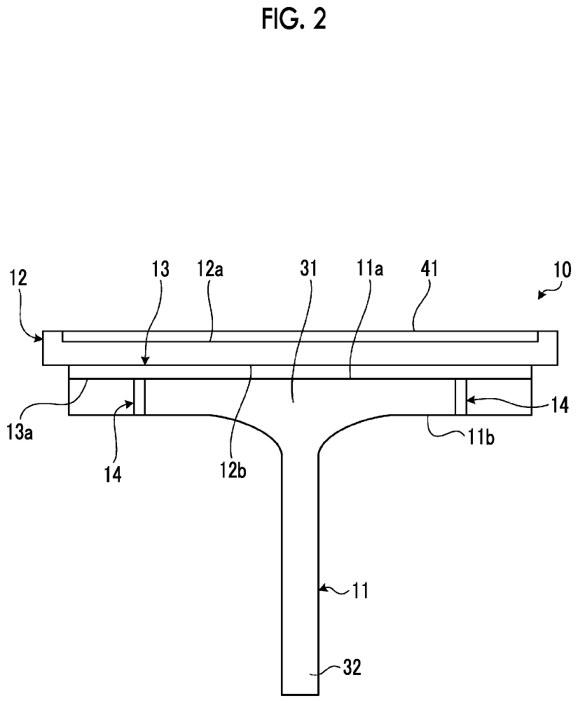

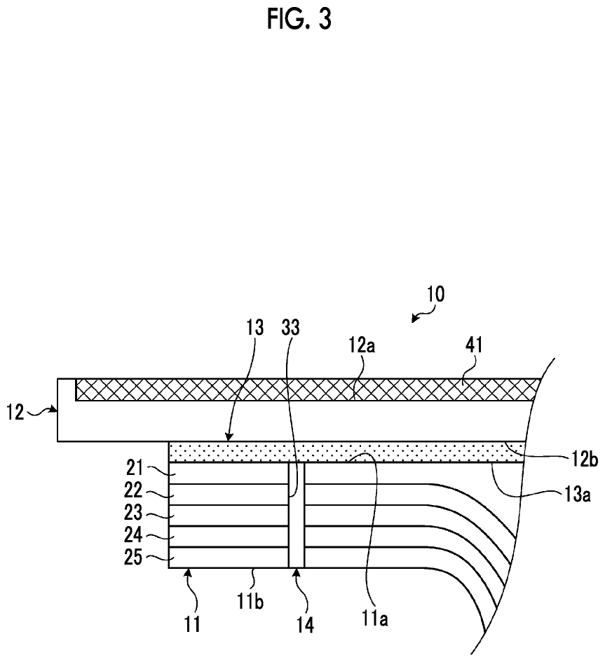

FIG. 1 is a perspective view illustrating a composite structure of a first embodiment, FIG. 2 is a cross-sectional view illustrating the composite structure of the first embodiment, and FIG. 3 is a cross-sectional view of main parts illustrating the composite structure of the first embodiment. Composite structures to be described below are provided as an example of those used for fuselages of aircrafts, but the present invention is not limited to being applied to fuselages of aircrafts, and is applicable to, for example, automobiles, vehicles, ships, and other structures.

In the first embodiment, as illustrated in FIGS. 1 to 3, a composite structure 10 includes a first composite material 11, a second composite material 12, an insulating adhesive layer 13, and a conductive member 14.

The first composite material 11 is formed by laminating a plurality of (five in the first embodiment) of first composite sheets 21, 22, 23, 24, and 25. Each of the first composite sheets 21, 22, 23, 24, and 25 includes a first reinforcing fiber having conductivity and a first resin impregnated in the first reinforcing fiber. The first resin may cover the first reinforcing fiber. The first composite sheets 21, 22, 23, 24, and 25 are T-shaped columnar bodies used for a stringer, a frame, a longeron, or the like in a fuselage of an aircraft. Specifically, the first composite material 11 is formed by integrating a flange 31 having a plate shape which is provided to face one plane of the second composite material 12, and a web 32 having a plate shape and extending along a direction orthogonal to the flange 31. However, the first composite material 11 is not limited to having a T shape, and may have any shape as long as the first composite material 11 can be connected to the second composite material 12 and has a surface to be integrated.

The second composite material 12 includes a second reinforcing fiber having conductivity and a second resin impregnated in the second reinforcing fiber. The second resin may cover the second reinforcing fiber. The second composite material 12 is a plate-shaped material used for a skin of a fuselage of an aircraft. Similarly to the first composite material 11, it is preferable that the second composite material 12 is formed by laminating a plurality of second composite sheets. A conductive mesh 41 is fixed to a surface 12a of the second composite material 12. However, the shape of the second composite material 12 is not limited to a plate shape, and may have any shape as long as the second composite material 12 can be connected to the first composite material 11 and has a surface to be integrated.

A reinforcing fiber in which approximately several hundred to several thousand basic fibers each having a size of 5 μm or more and 7 μm or less are bundled is provided as an example of both the first reinforcing fiber and the second reinforcing fiber. Carbon fibers having conductivity and metal fibers are provided as exemplary examples of the basic fibers forming the first reinforcing fiber and the second reinforcing fiber. However, in the first composite material 11 and the second composite material 12, glass fibers, aramid fibers, and plastic fibers may be mixed in addition to the first reinforcing fiber and the second reinforcing fiber that have conductivity.

A resin in which a main component is a thermosetting resin is provided as an example of both the first resin and the second resin, and examples of the resin include epoxy resin, polyester resin, and vinyl ester resin. However, in the first resin and the second resin, a thermoplastic resin may be mixed in addition to the thermosetting resin. Here, examples of the thermoplastic resin to be mixed include polyamide resin, polypropylene resin, acrylonitrile butadiene styrene (ABS) resin, polyetheretherketone (PEEK), polyetherketoneketone (PEKK), and polyphenylene sulfide (PPS), and the like. In addition, the first resin and the second resin are not limited to the above materials, and may be other resins.

When the resin impregnated in the reinforcing fiber is a thermosetting resin, the thermosetting resin can be in a softened state, a cured state, and a semi-cured state. The softened state is a state before the thermosetting resin is thermally cured. The softened state is a state where the thermosetting resin does not have self-supporting property, and is a state where the thermosetting resin cannot hold a shape when not supported by a support body. The softened state is a state where the thermosetting resin can undergo a thermal curing reaction when heated. The cured state is a state after the thermosetting resin is thermally cured. The cured state is a state where the thermosetting resin has self-supporting property, and is a state where the thermosetting resin can hold a shape even when not supported by a support body. The cured state is a state where the thermosetting resin cannot undergo a thermal curing reaction even when heated. The semi-cured state is a state between the softened state and the cured state. The semi-cured state is a state where the thermosetting resin has undergone thermal curing weaker than in the cured state. The semi-cured state is a state where the thermosetting resin has self-supporting property, and is a state where the thermosetting resin can hold a shape even when not supported by a support body. The semi-cured state is a state where the thermosetting resin can undergo a thermal curing reaction when heated. In the following description, an intermediate preform of a composite material in which a reinforcing fiber is impregnated with a non-cured thermosetting resin is appropriately referred to as a prepreg.

In the composite structure 10, the insulating adhesive layer 13 is provided between the first composite material 11 and the second composite material 12. The insulating adhesive layer 13 is a layer formed of an adhesive agent having electrical insulating property. The insulating adhesive layer 13 bonds a surface 11a of the flange 31 of the first composite material 11 and a surface 12b of the second composite material 12 to integrate the first composite material 11 and the second composite material 12, the surface 11a and the surface 12b facing each other. Since the composite structure 10 is formed by bonding the first composite material 11 and the second composite material 12 with the insulating adhesive layer 13, even when the cost reduction and the weight reduction of the entire structure are made, similarly, it is possible to implement an appropriate lightning protection measure.

The conductive member 14 connects the plurality of first composite sheets 21, 22, 23, 24, and 25 in the first composite material 11. The conductive member 14 connects only the plurality of first composite sheets 21, 22, 23, 24, and 25. The conductive member 14 is provided along a laminating direction of the plurality of first composite sheets 21, 22, 23, 24, and 25. One end portion of the conductive member 14 is provided up to an adhesion surface 13a of the insulating adhesive layer 13, and the other end of the conductive member 14 is provided up to a surface 11b of the first composite material 11. For this reason, the one end portion of the conductive member 14 is in contact with the adhesion surface 13a of the insulating adhesive layer 13, and the other end thereof is flush with the surface 11b of the first composite material 11.

The conductive member 14 is a penetration member penetrating through the plurality of first composite sheets 21, 22, 23, 24, and 25 in the laminating direction. Specifically, the conductive member 14 is a pin, a bolt, a bit, a screw, or the like. The first composite material 11 is provided with a through-hole 33 penetrating through the plurality of first composite sheets 21, 22, 23, 24, and 25. A pin as the conductive member 14 is press-fitted and fixed to the through-hole 33. In addition, a bolt, a bit, or a screw as the conductive member 14 is screwed and fixed so as to be press-fitted into the through-hole 33. Incidentally, the conductive member 14 is provided along the laminating direction orthogonal to the plurality of first composite sheets 21, 22, 23, 24, and 25, but may be provided along an angled laminating direction inclined with respect to the plurality of first composite sheets 21, 22, 23, 24, and 25.

In addition, a plurality of the conductive members 14 are provided at predetermined intervals along a longitudinal direction of the first composite material 11. It is preferable that the plurality of conductive members 14 are provided at equal intervals along the longitudinal direction of the first composite material 11. It is preferable that the conductive member 14 has conductivity where the electric resistance is lower than that of at least the first resin and higher than that of the first reinforcing fiber.

The composite structure 10 is provided with the conductive members 14 that connect the plurality of first composite sheets 21, 22, 23, 24, and 25 in the first composite material 11. For this reason, the conductive members 14 can be conducted to the plurality of first composite sheets 21, 22, 23, 24, and 25, and can appropriately set a path through which electricity from lightning flows.

When electricity from lightning reaches the second composite material 12, current flows through the conductive mesh 41, and a part of the current flows through the second composite material 12. Although the insulating adhesive layer 13 is provided between the first composite material 11 and the second composite material 12, a part of the current may flow to the first composite material 11 through the insulating adhesive layer 13. However, since the first composite material 11 is provided with the conductive members 14, the current that has flowed to the first composite sheet 21 flows to the other first composite sheets 22, 23, 24, and 25 through the conductive members 14. Then, the current that has flowed to the first composite material 11 is distributed by the conductive members 14, and flows through the plurality of first composite sheets 21, 22, 23, 24, and 25 along an in-plane direction. At this time, a uniform current easily flows through the plurality of first composite sheets 21, 22, 23, 24, and 25 along the in-plane direction, and a local flow of the current is suppressed.

In addition, in the composite structure 10, the plurality of conductive members 14 are disposed at the predetermined intervals, preferably at the equal intervals, along the longitudinal direction of the first composite material 11. For this reason, it is possible to reduce a potential difference when the current flows along the in-plane direction of the plurality of first composite sheets 21, 22, 23, 24, and 25.

### Second Embodiment

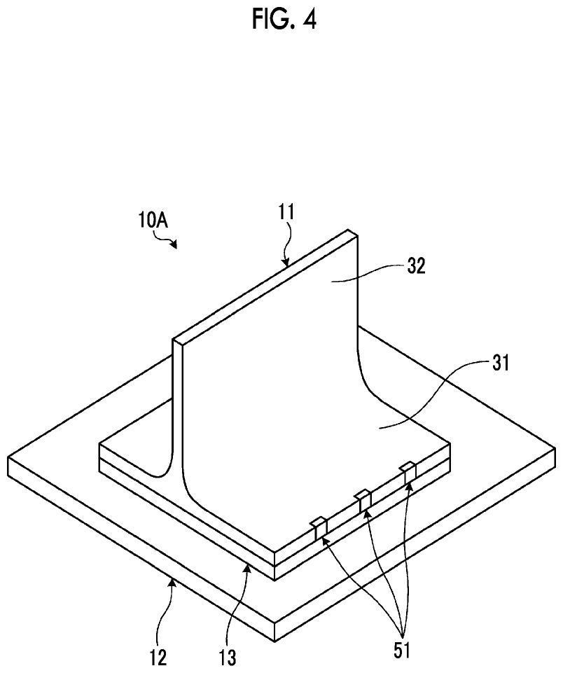

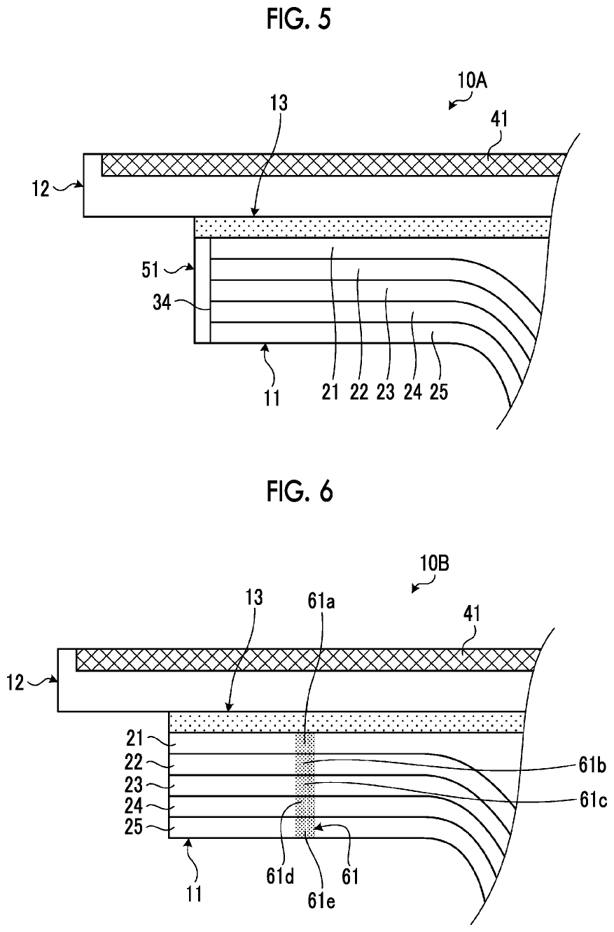

FIG. 4 is a perspective view illustrating a composite structure of a second embodiment, and FIG. 5 is a cross-sectional view of main parts illustrating the composite structure of the second embodiment. Incidentally, members having the same functions as those in the first embodiment described above are denoted by the same reference signs, and a detailed description thereof will be omitted.

In the second embodiment, as illustrated in FIGS. 4 and 5, a composite structure 10A includes the first composite material 11, the second composite material 12, the insulating adhesive layer 13, and a conductive member 51. The first composite material 11, the second composite material 12, and the insulating adhesive layer 13 are the same as those in the first embodiment.

The conductive member 51 connects the plurality of first composite sheets 21, 22, 23, 24, and 25 in the first composite material 11. The conductive member 51 connects only the plurality of first composite sheets 21, 22, 23, 24, and 25. The conductive member 51 is provided along the laminating direction of the plurality of first composite sheets 21, 22, 23, 24, and 25. One end portion of the conductive member 51 is provided up to the adhesion surface 13a of the insulating adhesive layer 13, and the other end of the conductive member 51 is provided up to the surface 11b of the first composite material 11. For this reason, the one end portion of the conductive member 51 is in contact with the adhesion surface 13a of the insulating adhesive layer 13, and the other end thereof is flush with the surface 11b of the first composite material 11.

The conductive member 51 is an attachment member attached to end surfaces of the plurality of first composite sheets 21, 22, 23, 24, and 25 along the laminating direction. Specifically, the conductive member 51 is a conductive plate, a conductive paste, a conductive film, a conductive tape, a conductive sheet, a conductive mesh, or the like. In the first composite material 11, cutouts 34 are provided in the end surfaces of the plurality of first composite sheets 21, 22, 23, 24, and 25. A conductive film, a conductive tape, a conductive sheet, or a conductive mesh as the conductive member 51 is bonded and fixed to the cutouts 34.

In addition, a plurality of the conductive members 51 are provided at predetermined intervals along the longitudinal direction of the first composite material 11. It is preferable that the plurality of conductive members 51 are provided at equal intervals along the longitudinal direction of the first composite material 11.

Incidentally, actions and effects of the composite structure 10A of the second embodiment are the same as those in the first embodiment, and a description thereof will be omitted.

### Third Embodiment

FIG. 6 is a cross-sectional view of main parts illustrating a composite structure of a third embodiment. Incidentally, members having the same functions as those in the first embodiment described above are denoted by the same reference signs, and a detailed description thereof will be omitted.

In the third embodiment, as illustrated in FIG. 6, a composite structure 10B includes the first composite material 11, the second composite material 12, the insulating adhesive layer 13, and a conductive member 61.

The first composite material 11, the second composite material 12, and the insulating adhesive layer 13 are the same as those in the first embodiment.

The conductive member 61 connects the plurality of first composite sheets 21, 22, 23, 24, and 25 in the first composite material 11. The conductive member 61 connects only the plurality of first composite sheets 21, 22, 23, 24, and 25. The conductive member 61 is provided along the laminating direction of the plurality of first composite sheets 21, 22, 23, 24, and 25. One end portion of the conductive member 61 is provided up to the adhesion surface 13a of the insulating adhesive layer 13, and the other end of the conductive member 61 is provided up to the surface 11b of the first composite material 11. For this reason, the one end portion of the conductive member 61 is in contact with the adhesion surface 13a of the insulating adhesive layer 13, and the other end thereof is flush with the surface 11b of the first composite material 11.

The conductive member 61 is an additive added to the first reinforcing fiber or to the first resin. Specifically, during molding of the first composite material 11, the conductive member 61 is locally added to the first reinforcing fiber or to the first resin, as an additive such as powder of conductive carbon or metal oxide. Namely, the conductive member 61 is filling portions 61a, 61b, 61c, 61d, 61e that are locally provided in the plurality of first composite sheets 21, 22, 23, 24, and 25.

In addition, a plurality of the conductive members 61 are provided at predetermined intervals along the longitudinal direction of the first composite material 11. It is preferable that the plurality of conductive members 61 are provided at equal intervals along the longitudinal direction of the first composite material 11.

Incidentally, actions and effects of the composite structure 10B of the third embodiment are the same as those in the first embodiment, and a description thereof will be omitted.

### Actions and Effects of Present Embodiments

The composite structure according to a first aspect includes the first composite material 11 in which the plurality of first composite sheets 21, 22, 23, 24, and 25 in each of which the first reinforcing fiber having conductivity is impregnated with the first resin are laminated; the second composite material 12 in which the second reinforcing fiber having conductivity is impregnated with the second resin; the insulating adhesive layer 13 disposed between the first composite material 11 and the second composite material 12 to bond the first composite material 11 and the second composite material 12; and the conductive member 14, 51, or 61 that connects the plurality of first composite sheets 21, 22, 23, 24, and 25.

In the composite structure according to the first aspect, when electricity from lightning flows from the second composite material 12 to the first composite material 11 through the insulating adhesive layer 13, current is distributed to the plurality of first composite sheets 21, 22, 23, 24, and 25 by the conductive member 14, and flows therethrough along the in-plane direction. For this reason, it is possible to suppress a local flow of the current through the plurality of first composite sheets 21, 22, 23, 24, and 25. As a result, it is possible to implement a lightning protection measure while suppressing an increase in weight.

In the composite structure according to a second aspect, the conductive member 14, 51, or 61 connects only the plurality of first composite sheets 21, 22, 23, 24, and 25. Accordingly, since the conductive member 14, 51, or 61 connects only the first composite sheets 21, 22, 23, 24, and 25, and does not penetrate through the insulating adhesive layer 13, it is possible to maintain insulating performance of the insulating adhesive layer 13.

In the composite structure according to a third aspect, the conductive member 14, 51, or 61 is provided along the laminating direction of the plurality of first composite sheets 21, 22, 23, 24, and 25, and is provided up to the adhesion surface 13a of the insulating adhesive layer 13. Accordingly, when the current that has flowed through the second composite material 12 reaches the first composite material 11 through the conductive member 14, 51, 61, the current can be properly distributed to the plurality of first composite sheets 21, 22, 23, 24, and 25 by the conductive member 14, 51, or 61.

In the composite structure according to a fourth aspect, the conductive member 14, 51, or 61 is provided along the laminating direction of the plurality of first composite sheets 21, 22, 23, 24, and 25, and is provided up to the surface 11b of the first composite material 11.

Accordingly, the current that has reached the first composite material 11 can be properly distributed to the plurality of first composite sheets 21, 22, 23, 24, and 25 by the conductive member 14, 51, or 61.

In the composite structure according to a fifth aspect, the conductive member 14 is a penetration member penetrating through the plurality of first composite sheets 21, 22, 23, 24, and 25 in the laminating direction.

Accordingly, it is possible to properly connect the conductive member 14 and the plurality of first composite sheets 21, 22, 23, 24, and 25.

In the composite structure according to a sixth aspect, the conductive member 51 is an attachment member attached to the end surfaces of the plurality of first composite sheets 21, 22, 23, 24, and 25 along the laminating direction. Accordingly, it is possible to simplify the structure by eliminating the need for drilling the first composite sheets 21, 22, 23, 24, and 25.

In the composite structure according to a seventh aspect, the conductive member 61 is an additive added to the first reinforcing fiber or to the first resin. Accordingly, it is possible to simplify the structure by eliminating the need for the post-processing or the like of the first composite sheets 21, 22, 23, 24, and 25.

In the composite structure according to an eighth aspect, the plurality of conductive members 14, 51, or 61 are provided at predetermined intervals along the longitudinal direction of the first composite material 11.

Accordingly, it is possible to reduce a potential difference when current flows along the in-plane direction of the plurality of first composite sheets 21, 22, 23, 24, and 25.

### REFERENCE SIGNS LIST

10, 10A, 10B Composite structure
11 First composite material
11a, 11b Surface
12 Second composite material
12a, 12b Surface
13 Insulating adhesive layer
13a Adhesion surface
14, 51, 61 Conductive member
21, 22, 23, 24, 25 First composite sheet
31 Flange
32 Web
33 Through-hole
34 Cutout

1. A composite structure comprising:
a first composite material in which a plurality of first composite sheets in each of which a first reinforcing fiber having conductivity is impregnated with a first resin are laminated;
a second composite material in which a second reinforcing fiber having conductivity is impregnated with a second resin;
an insulating adhesive layer disposed between the first composite material and the second composite material to bond the first composite material and the second composite material; and
a conductive member that connects the plurality of first composite sheets, the conductive member being provided up to an adhesion surface between the first composite material and the insulating adhesive layer.

2. The composite structure according to claim 1,
wherein the conductive member connects only the plurality of first composite sheets.

3. The composite structure according to claim 1,
wherein the conductive member is provided along a laminating direction of the plurality of first composite sheets, and is provided up to an adhesion surface of the insulating adhesive layer.

4. The composite structure according to claim 1,
wherein the conductive member is provided along a laminating direction of the plurality of first composite sheets, and is provided up to a surface of the first composite material.

5. The composite structure according to claim 1,
wherein the conductive member is a penetration member penetrating through the plurality of first composite sheets along a laminating direction.

6. The composite structure according to claim 1,
wherein the conductive member is an attachment member attached to end surfaces of the plurality of first composite sheets along a laminating direction.

7. The composite structure according to claim 1,
wherein the conductive member is an additive added to the first reinforcing fiber or to the first resin.

8. The composite structure according to claim 1,
wherein a plurality of the conductive members are provided at predetermined intervals along a longitudinal direction of the first composite material.
